(19) United States
(12) Patent Application Publication
(10) Pub. No.: US 2010/0013989 A1
(43) Pub. Date: Jan. 21, 2010

(54) METHOD AND SYSTEM FOR CONTROLLING FALLBACK IN GENERATING INTERMEDIATE FIELDS OF A VIDEO SIGNAL

(75) Inventors: Zhi Zhou, Corona, CA (US); Yeong-Taeg Kim, Irvine, CA (US)

Correspondence Address: Myers Andras Sherman LLP, 19900 MacArthur Blvd., Suite 1150, Irvine, CA, 92612, US

(73) Assignee: Samsung Electronics Co. Ltd., Suwon City (KR)

(21) Appl. No.: 12/176,221

(22) Filed: Jul. 18, 2008

(51) Int. Cl. H04N 7/01

(52) U.S. Cl. 348/441; 348/E07.003

(57) ABSTRACT

A method and system for generating intermediate fields of a video signal are provided. One implementation involves generating intermediate fields of a video signal, by performing interpolation for generating said intermediate (missing) fields of said video signal; and applying fallback interpolation when quality of the interpolated fields is below a threshold or when valid motion information cannot be determined. Fallback interpolation involves estimating a global motion of a scene represented by the video signal, determining a periodic motion count based on the estimated global motion, and controlling application of fallback interpolation based on said periodic motion count.

### FIELD OF THE INVENTION

The present invention relates generally to video signal processing and in particular to controlling fallback speed in frame rate conversion and motion judder cancellation in video signals.

### BACKGROUND OF THE INVENTION

In many video display systems, certain video frames (missing frames) are generated based on temporally and/or spatially neighboring frames. In frame rate conversion (FRC) and motion judder cancellation (MJC), normally the missing frames are interpolated using motion compensation approaches for moving objects in the interpolated frames. However, in certain scenes, such as irregular motion, the quality of interpolated frames is very low because such frames typically include artifacts such as halo and blockiness. In such cases, fallback techniques are used instead of FRC/MJC to hide the artifacts. In practice, the quality of the normally interpolated frames in terms of reliability in quality is first detected. If the normally interpolated frames are not reliable, then fallback is applied. Conventional methods, however, lack the ability to properly control application of fallback vs. normal interpolation, for generating high quality frames from other frames.

### BRIEF SUMMARY OF THE INVENTION

The present invention provides a method and system for controlling fallback in generating intermediate fields of a video signal. One embodiment involves generating intermediate fields of a video signal, by performing interpolation for generating said intermediate (missing) fields of said video signal; and applying fallback interpolation when quality of the interpolated fields is below a threshold or when valid motion information cannot be determined. Fallback interpolation involves estimating a global motion of a scene represented by the video signal, determining a periodic motion count based on the estimated global motion, and controlling application of fallback interpolation based on said periodic motion count.

These and other features, aspects and advantages of the present invention will become understood with reference to the following description, appended claims and accompanying figures.

### BRIEF DESCRIPTION OF THE DRAWINGS

FIGS. 1A-B show example fallback processes.

FIG. 2 shows a functional block diagram of an embodiment of a system for video processing by controlling fallback speed.

FIG. 3 shows an example process for controlling fallback speed in video signal processing.

FIG. 4 shows an example of determining motion vector change.

### DETAILED DESCRIPTION OF THE INVENTION

The present invention provides a method and system for controlling fallback generating intermediate fields of a video signal based on periodic motion detection in the video signal. In frame rate conversion (FRC) and motion judder cancellation (MJC), smoothly changing scenes in multiple frames require smooth transition between fallback and normal interpolation in generating intermediate (missing) frames. However, other scenes including shaking objects require fast switching between fallback and interpolation in generating missing frames from existing frames. The invention provides a method and system for controlling speed of switching between fallback and interpolation in generating missing (intermediate) video frames (fields) from existing video frames (fields).

One embodiment involves generating intermediate fields of a video signal, by performing interpolation for generating said intermediate (missing) fields of said video signal; and applying fallback interpolation when quality of the interpolated fields is below a threshold or when valid motion information cannot be determined. Said fallback interpolation includes estimating a global motion of a scene represented by the video signal, determining a periodic motion count based on the estimated global motion, and controlling application of fallback interpolation based on said periodic motion count.

Controlling application of fallback interpolation can further include determining a pace for application of fallback interpolation based on the periodic motion count, and controlling application of fallback interpolation based on said pace. Said pace for application of fallback interpolation may include determining a target interpolation phase based on an interpolation quality reliability measurement. Said pace for application of fallback interpolation may include determining a mixing ratio for mixing a field with temporal interpolation thereof, based on an interpolation quality reliability measurement.

Estimating a global motion may include performing block-based motion estimation to obtain motion vectors, and estimate global motion from a histogram of the motion vectors. Determining a periodic motion count may include counting change in the motion vectors based on motion thresholds indicating large motion (e.g., large vertical motion).

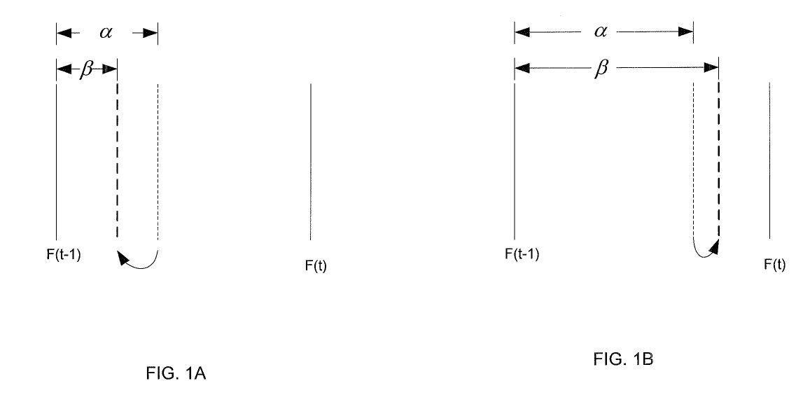

Referring to drawings according to the present invention, an example implementation of the invention is now described. Fallback may be applied by shifting an interpolation phase α, as shown by example in FIGS. 1A-B. Two temporal fields or frames F(t) and F(t−1), at times t and t−1, respectively, are shown. A missing frame is at phase α. In FIG. 1A, instead of normally interpolating a frame at phase α, the interpolation phase is shifted to a frame at phase β to be interpolated, wherein phase β is closer to the original frame F(t−1). The closer the phase is shifted to an original frame, the more artifact reduction in the missing frame generated by interpolation. When β is 0 or 1, instead of interpolation, the original frame is repeated (but this may generate artifacts-motion judder from frame to frame). In FIG. 1A, α<=0.5, while in FIG. 1B, α>0.5 and phase β is closer to F(t).

In case of a sudden fallback, smooth motion suddenly results in judder. A smooth transition into, and out of, fallback is thus implemented to ensure the motion gradually changes from smooth-to-judder in entering fallback, and judder-to-smooth in exiting fallback. This is achieved based on a reliability measure, to determine a fallback pace δ at each step, and the phase shifting is within this pace. Table 1 below shows an example of how the phase is shifted. Note that, the pace δ and target phase β are dynamically changing at each step (i.e., t−1, t, t+1, . . . , t+n), based on reliability detection. The δ here refers to the speed of entering/exiting fallback. The higher δ, the faster the convergence.

TABLE 1

| Time | Phase | Shifted phase |
|---|---|---|
| t − 1 | A | A |
| t | α | α − δ(t) |
| t + 1 | α | α − δ(t) − δ(t + 1) |
| t + 2 | α | α − δ(t) − δ(t + 1) − δ(t + 2) |
| . . . | α | . . . |
| t + n | α | β (t + n) |

Another fallback approach involves mixing a normally interpolated frame with temporal interpolation results. For example, let F(α) denote the interpolated frame, and T(α) denote the temporal interpolated result, whereby:

T(α)=F(t−1)*(1−α)+F(t)*a. (1)

The final output O(α) can be represented as:

O(α)=F(α)*r+T(α)*(1−r), (2)

where r denotes a mixing ratio. If r=1, there is no fallback in generating the missing (intermediate) frame. If r=1, generating the missing frame is completely by fallback, otherwise, it is partially fallback. As above, the speed of entering into and exiting out of fallback can be controlled by setting the pace δ, denoting the maximum amount that the mixing ratio r is allowed to change at each step. The pace δ and the target mixing ratio r are dynamically changing at each step based on the reliability detection.

If a scene (comprising multiple frames/fields) depicts shaking objects (e.g., an earthquake scene or a camera shaking in a vertical direction), artifacts may be generated in the interpolated (missing/intermediate) frames. Controlling fallback speed according to the invention reduces such artifacts. In case of vertical shaking, entering/exiting speed of fallback increases.

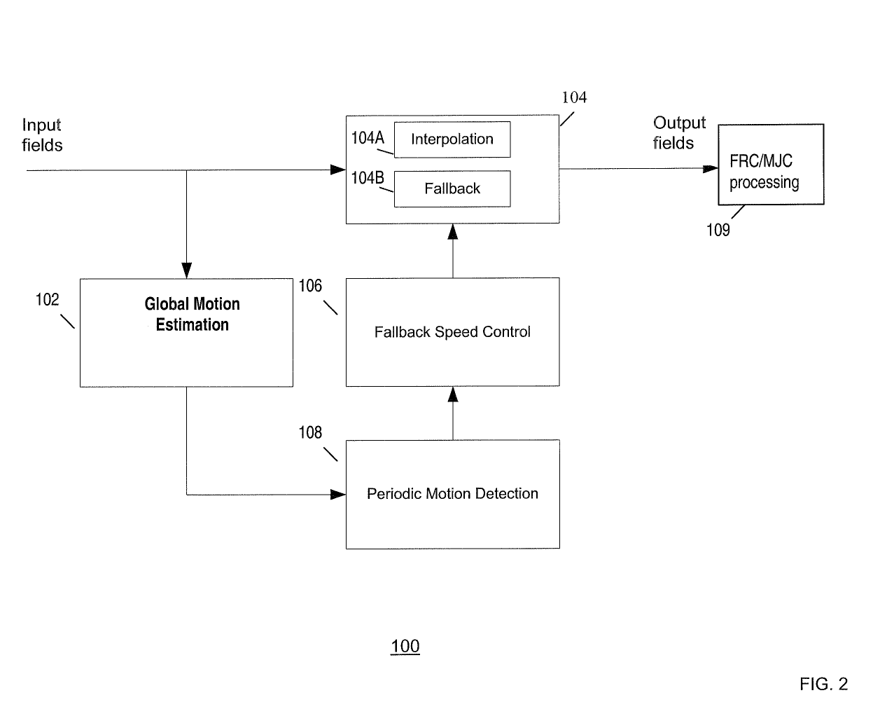

FIG. 2 shows a functional block diagram of an image processing system 100 implementing an embodiment of the present invention. The system 100 includes a global motion estimation module 102, a processing module 104, a fallback speed control module 106 and a periodic motion detection module 108. The processing module 104 includes a normal interpolation function 104A and a fallback function 104B. The global motion estimation module 102 estimates a global motion vector (e.g., vertical, horizontal, combination). The periodic motion detection module 108 detects and counts the number of significant motion (e.g., periodic motion such as significant shaking of an object from frame to frame) for the past n frames. The fallback speed control module 106 uses the count to control the speed (pace) of application of normal interpolation 104A vs. fallback interpolation 104B. Controlling speed of switching between fallback and interpolation in generating missing (intermediate) video frames from existing video frames is useful for video signal for video processing (MJC/FRC) 109. This improves the performance of FRC/MJC by reducing blockiness and halo in the output results.

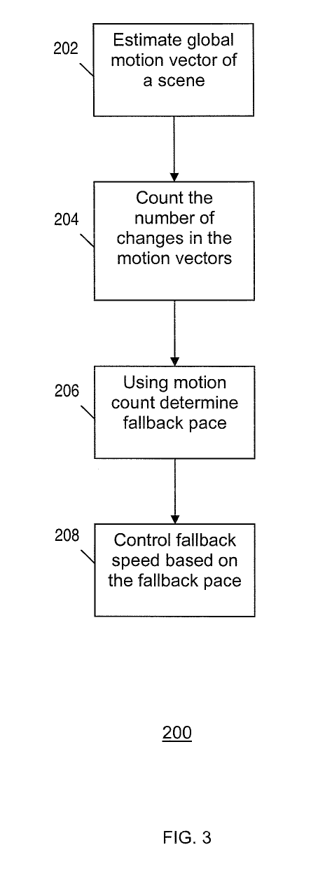

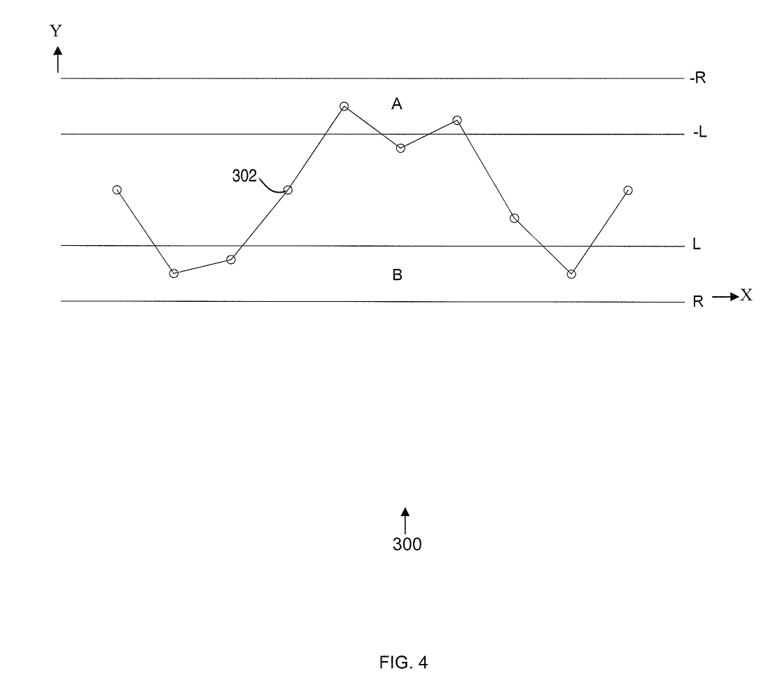

The system 100 implements the following example process 200 as shown in FIG. 3:
Block 202: In module 102, estimate a global motion of a scene comprising multiple digital video fields/frames. One example involves applying block-based motion estimation, and then estimating a vertical global motion from the histogram of the vertical motion vectors.
Block 204: In module 108, perform periodic motion detection by counting the number of changes in the motion vectors. For example, at time t, save the past n vertical global motion vectors into a buffer and generate a plot 300 therefrom as shown in FIG. 4. The horizontal axis (X-axis) represents time t, the vertical axis (Y-axis) represents motion vector size, each small circle 302 denotes each vertical global motion vector of the corresponding frame, [−R, R] represents vertical search range, and [−L, L] represents a pair of thresholds. A first zone A denotes the range [−R, −L] and a second zone B denotes the range [L, R]. If the motion vector is in either zone A or zone B, then the motion vector indicates a large/significant motion. A periodic motion count C(t) represents the number of the motion vectors change from zone A to zone B, or from zone B to zone A for the frame at time t (e.g., F(t)). In the transition between zones A and B, the intermediate motion vector can stay anywhere. A higher count indicates higher shaking level in the scene.
Block 206: In module 106, using the periodic motion count, determine the pace δ(t) for fallback speed control. If C(t) is less than a threshold C1, the pace δ(t) is set to a small value δ1 to slow down entering/exiting fallback. If C(t) is larger than a threshold C2, then δ(t) is set to a large value δ2 to quicken entering/exiting fallback. If C(t) is in the middle of C1 and C2, then δ(t) is interpolated linearly from δ1 and δ2.
Block 208: Use the pace δ(t) is to control fallback entry/exit speed of the module 104. The fallback function 104B determines the target phase or mixing ratio based on the count of periodic motion vectors.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. Further, embodiments of the invention can take the form of an entirely hardware embodiment, an entirely software embodiment or an embodiment containing both hardware and software elements.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device.

The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read only memory (CD-ROM), compact disk-read/write (CD-R/W) and DVD.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Though the present invention has been described with reference to certain versions thereof; however, other versions are possible. Therefore, the spirit and scope of the appended claims should not be limited to the description of the preferred versions contained herein.

What is claimed is:

1. A method for generating intermediate fields of a video signal, comprising:
performing interpolation for generating said intermediate fields of said video signal; and
applying fallback interpolation when quality of the interpolated fields is below a threshold or when valid motion information cannot be determined, said fallback interpolation comprising:
estimating a global motion of a scene represented by the video signal;
determining a periodic motion count based on the estimated global motion; and
controlling application of fallback interpolation based on said periodic motion count.

2. The method of claim 1, wherein controlling application of fallback interpolation further includes determining a pace for application of fallback interpolation based on the periodic motion count, and controlling application of fallback interpolation based on said pace.

3. The method of claim 2, wherein said pace for application of fallback interpolation determines a target interpolation phase based on an interpolation quality reliability measurement.

4. The method of claim 2, wherein said pace for application of fallback interpolation determines a mixing ratio for mixing a field with temporal interpolation thereof, based on an interpolation quality reliability measurement.

5. The method of claim 1, wherein estimating a global motion includes:
performing block-based motion estimation to obtain motion vectors; and
estimate global motion from a histogram of the motion vectors.

6. The method of claim 5, wherein determining a periodic motion count includes counting change in the motion vectors based on motion thresholds indicating large motion.

7. The method of claim 1, wherein each field comprises a frame.

8. An apparatus for generating intermediate fields of a video signal, comprising:
an interpolation function configured for performing interpolation for generating said intermediate fields of said video signal;
an estimating module configured for estimating a global motion of a scene represented by the video signal;
a motion count module configured for determining a periodic motion count based on the estimated global motion;
a fallback function configured for applying fallback interpolation; and
a controlling module configured for controlling application of the fallback interpolation function and the interpolation function based on said periodic motion count when quality of the interpolated fields is below a threshold or when valid motion information cannot be determined.

9. The apparatus of claim 8, wherein the controlling module is further configured for controlling application of fallback interpolation by determining a pace for application of fallback interpolation based on the periodic motion count, and controlling application of fallback interpolation based on said pace.

10. The apparatus of claim 9, wherein said pace for application of fallback interpolation determines a target interpolation phase based on an interpolation quality reliability measurement.

11. The apparatus of claim 9, wherein said pace for application of fallback interpolation determines a mixing ratio for mixing a field with temporal interpolation thereof, based on an interpolation quality reliability measurement.

12. The apparatus of claim 8, wherein the estimating module is further configured for estimating a global motion by performing block-based motion estimation to obtain motion vectors and estimate global motion from a histogram of the motion vectors.

13. The apparatus of claim 12, wherein motion count module is further configured for determining a periodic motion count by counting change in the motion vectors based on motion thresholds indicating large motion.

14. The apparatus of claim 8, wherein each field comprises a frame.

15. A video processing system, comprising:
a processing module configured for generating intermediate fields of a video signal, including:
an interpolation function configured for performing interpolation for generating said intermediate fields of said video signal;
an estimating module configured for estimating a global motion of a scene represented by the video signal;
a motion count module configured for determining a periodic motion count based on the estimated global motion;
a fallback function configured for applying fallback interpolation; and
a controlling module configured for controlling application of the fallback interpolation function and the interpolation function based on said periodic motion count when quality of the interpolated fields is below a threshold or when valid motion information cannot be determined; and
a motion compensation module configured for frame rate conversion (FRC) and/or motion judder cancellation (MJC) using the intermediate fields.
